(19) United States
(12) Patent Application Publication
(10) Pub. No.: US 2022/0284178 A1
(43) Pub. Date: Sep. 8, 2022

(54) TECHNIQUES TO AUTOMATICALLY AND SECURELY PROVIDE SENSITIVE DATA IN DATA ELECTRONIC FIELDS

(71) Applicant: Capital One Services, LLC, McLean, VA (US)

(72) Inventors: Jeffrey RULE, Chevy Chase, MD (US); Kevin OSBORN, Newton, MA (US); Wayne LUTZ, Fort Washington, MD (US)

(73) Assignee: Capital One Services, LLC, McLean, VA (US)

(21) Appl. No.: 17/192,486

(22) Filed: Mar. 4, 2021

(51) Int. Cl. G06F 40/174; G06Q 20/34; G06F 21/35

(52) U.S. Cl. CPC G06F 40/174; G06Q 20/352; G06F 21/35

(57) ABSTRACT

Embodiments discussed here are directed to systems, methods, and techniques to automatically populate sensitive data in electronic forms or fields.

### BACKGROUND

On a daily basis, we typically interact with mobile platforms, such as websites and native mobile applications. These platforms sometimes require users to enter personal and/or sensitive data in fields or forms. For example, electronic commerce (e-commerce) systems allow users to perform transaction for goods and/or services from the comfort of their home. Typically, a user interfaces with the e-commerce system via an application, such as through a website in a web browser or in the native mobile application.

The e-commerce systems typically include virtual shopping carts and checkout processes. In most instances, the checkout process involves the user entering payment information (such as credit card or debit card information) and other personal information to complete an order. However, this process may be cumbersome to the user especially when the user is performing the transaction on a handheld device such as a mobile device. For instance, the checkout process may require the user to provide detailed payment information in a number of fields, such as account information, a user's name, a phone number, an address, and so forth. It is common for users using a commerce checkout process to have difficulty entering information, run out of time, or become frustrated with the checkout process. Such frustrations often cause potential consumers to abandon their transactions. Users have similar experiences with other types of websites or applications that require the user to enter sensitive data, e.g., medical systems, banking systems, etc. Thus, embodiments discussed herein aim to improve systems and processes that require users to enter data in a secure manner.

### BRIEF SUMMARY

Embodiments discussed herein may be generally directed to systems, devices, method, and techniques to automatically populate fields with sensitive data by authenticating a user, determining the data to populate. For example, embodiments may include a mobile device configured to automatically populate fields of webpages with new or updated information, including processing circuitry, and a memory coupled with the processing circuitry, the memory to store instructions that when executed by the processing circuitry, cause the processing circuitry to detect an initiation of a communication with a contactless card, perform, via a wireless interface, the communication with the contactless card, the communication comprising receiving authentication information from the contactless card, and detect one or more fields of a webpage of an online system, the one or more fields configured to receive data. Embodiments also include the processing circuitry to determine information to identify the online system, communicate the authentication information, and the information to identify the online system to a server, the server to obtain the data based on the authentication information and the information to identify the online system, receive the data from the server, and automatically populate the one or more fields of the webpage with the data.

Embodiments also include a system, comprising one or more processors, and memory coupled with the one or more processors. The memory to store instructions that when executed by the one or more processors, cause the one or more processors to, receive and process authentication information associated with a contactless card, and identity information to identify an online system. The system may also perform an authentication operation associated with the contactless card and determine whether the authentication operation is successful or unsuccessful. In response to the authentication operation being successful, the system may determine data capable to populate one or more fields of a webpage associated with the online system and send the data to the mobile device, and in response to the authentication operation being unsuccessful, the system may send an indication to the mobile device to indicate an unsuccessful authentication of the authentication information.

Embodiments may also include a computing device, comprising processing circuitry; and memory coupled with the processing circuitry. The memory to store instructions that when executed by the processing circuitry, cause the processing circuitry to detect one or more fields of a webpage to populate with data, perform an authentication operation with a contactless card to authenticate a user, determine the data to populate the one or more fields based on the webpage and a successful result of the authentication operation, and populate the one or more fields of the webpage with the data.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system 100 in accordance with embodiments.

FIG. 2 illustrates an example sequence flow 200 in accordance with embodiments.

FIG. 3 illustrates a routine 300 in accordance with one embodiment.

FIG. 4 illustrates a routine 400 in accordance with one embodiment.

FIG. 5 illustrates a contactless card 500 in accordance with embodiments.

FIG. 6 illustrates a transaction card component 600 in accordance with embodiments.

FIG. 7 illustrates a sequence flow 700 in accordance with one embodiment.

FIG. 8 illustrates a data structure 800 in accordance with embodiments.

FIG. 9 is a diagram of a key system 900 in accordance with embodiments.

FIG. 10 illustrates a routine 1000 to generate a cryptogram in accordance with embodiments.

FIG. 11 illustrates a routine 1100 in accordance with embodiments.

FIG. 12 illustrates a routine 1200 in accordance with embodiments.

FIG. 13 illustrates a computer architecture 1300 in accordance with one embodiment.

FIG. 14 illustrates a communications architecture 1400 in accordance with one embodiment.

### DETAILED DESCRIPTION

Embodiments discussed here are directed to methods, systems, and techniques to automatically populate fields in a webpage or mobile application with data in a secure manner. For example, the techniques may include determining that sensitive data is required to be entered into a field or form, performing an authentication operation to authenticate a user, and determining the sensitive data to populate in the field(s) or form. The sensitive data may be provided and/or automatically populated into one or more fields of the webpage or mobile application to perform a task or operation.

In one example, the task may be a checkout operation to purchase goods and/or services, and the sensitive data may be account or payment data to populate in one or more fields to make the purchase. Embodiments include detecting and/or determining that secure data is required for a field or form displayed in a web browser or application, and initiating an authentication operation by having a user to tap a contactless card to the computing device to authenticate the user. The computing device may communicate with a server to perform the authentication operation and determine the data to populate in the webpage or mobile application. For example, the computing device may send information from the contactless card and information related to the webpage/mobile application to the server. The server may perform the authentication operation utilizing the data from the contactless card. If the user is authenticated, the server may also determine the data required to populate the webpage or mobile application. For example, the server may automatically retrieve payment data to provide to the computing device and automatically populate in the webpage or mobile application. In some instances, the payment data may be the account information for the contactless card. However, in other instances, the server may perform one or more optimization operations to determine the most optimal payment data to provide for the webpage or mobile application. The most optimal payment data may be based on one or more criteria, such as the payment data that will provide the most rewards, e.g., cashback, travel points, airline miles, hotel points, discounts at the merchant, etc. In other instances, the criteria may include payment data related to an account that has sufficient funds to perform the purchase. Embodiments are not limited to these examples.

As previously discussed, today's solutions are problematic because they require users to enter secure data manually, which is inconvenient and prone to errors. The operations discussed herein solve these and other problems by enabling a user to perform one operation, e.g., tapping a contactless card on or near a device, to authenticate the user and populate the secure information in a webpage or mobile application. Embodiments discussed herein also provide improvements to computers in processing these webpage or mobile application fields. For example, the solutions discussed herein provide secure manner to auto populate the fields with accurate data on the first attempt. In previous systems, when a user incorrectly enters information or data in a field, the data is communicated to a backend system that processes the data. The backend system has to process the data, determine the data is incorrect and communicate an error message to the user. The system will then have to perform the same processing again with correct data. Embodiments discussed herein improves this processing by ensure that the data is accurate the first time it is entered into the fields. Thus, systems will experience fewer errors and communicate less data saving processing/communication time and costs.

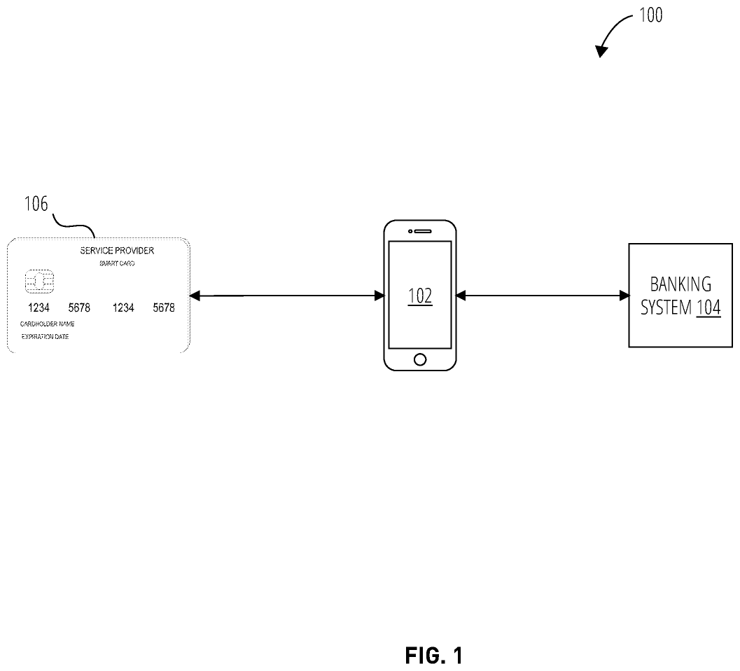

FIG. 1 illustrates an example of a system 100 configured to perform one or more operations discussed herein. Specifically, the system 100 includes one or more devices and systems that may be used by a user to automatically populate one or more fields of a webpage or mobile application. The illustrated system 100 includes a contactless card 106, a computing device 102, and a banking system 104 coupled via one or more interconnects, such as wired and wireless networking connections. System 100 shows a limited number of components, devices, and systems for discussion purposes, but system 100 includes additional components, devices, and systems not shown to enable the operations discussed herein.

In embodiments, the computing device 102 may be any type of computing device, such as a mobile device, a mobile phone device, a personal digital assistant, a tablet, and so forth. In embodiments, the computing device 102 may also be a computer, a personal computer, a desktop computer, a laptop computer, a server, a cloud-based computer, and so forth. The computing device 102 may include a number of components, including processing circuitry, such as one or more processors and/or processing components, memory, storage, one or more interfaces, one or more displays, and so forth. One or more interfaces may include network adapters that are configured to communicate wired and wirelessly. The wireless interfaces may include those configured to conduct cellular communications, Wireless Fidelity (WiFi) communication, and short-range communications, such as a Bluetooth interface, a near-field communication (NFC) interface, and so forth.

In embodiments, the computing device 102 also stores and is configured to execute software instructions to perform operations discussed herein, including one or more operating systems (OSs) configured to coordinate operations performed between higher-level software, such as applications and the hardware components of the computing device 102. Embodiments discussed herein may be configured to operate in accordance with any OS, including the Android® OS, Windows® OS, Apple® OS, and so forth.

The computing device 102 may include additional software, such as applications (apps). In embodiments, the computing device 102 may include an app configured to enable users to shop for goods and services and perform transactions. An app may be a standalone app, e.g., created by the merchant, and provide an interface to a backend system, such as online merchant systems. In embodiments, the computing device 102 also includes one or more web browser apps that enable users to access and view websites; and, in some instances, merchant websites provided by the online merchant systems. In these instances, the user may perform transactions with the online merchant system via the website presented in the web browser. The computing device 102 may include other apps that are configured to perform the operations discussed herein, such as banking apps, investment apps, hotel apps, airline apps, e-mail apps, social media apps, communications apps, medical apps, and so forth.

In embodiments, the computing device 102 also includes a banking app configured to interface with one or more other apps on the computing device 102, the banking system 104, and the contactless card 106. In embodiments, the banking app may be configured with one or more application programming interfaces (APIs) such that the apps and web browsers may interface and communicate with the banking app to perform one or more operations discussed herein. For example, an app or web browser may interface with the banking app when data is required for one or more fields, e.g., during a checkout process to perform a transaction to determine payment information, providing loan application data, providing medical data, etc. The banking app may perform one or more of authenticating the user by communicating with the contactless card and server, determining the data to populate in the fields or form, and causing the data to populate automatically. However, in other instances, instructions or code to perform the operations discussed herein may be embedded and/or included in the native or third-party applications themselves. For example, a merchant's application may include the instructions to perform the authentication operations, communicate with a server to determine the sensitive data, and automatically populate and/or insert the sensitive information into the appropriate fields or data entry areas. In another example, the web browser may include the instructions and/or a plugin to perform the operations.

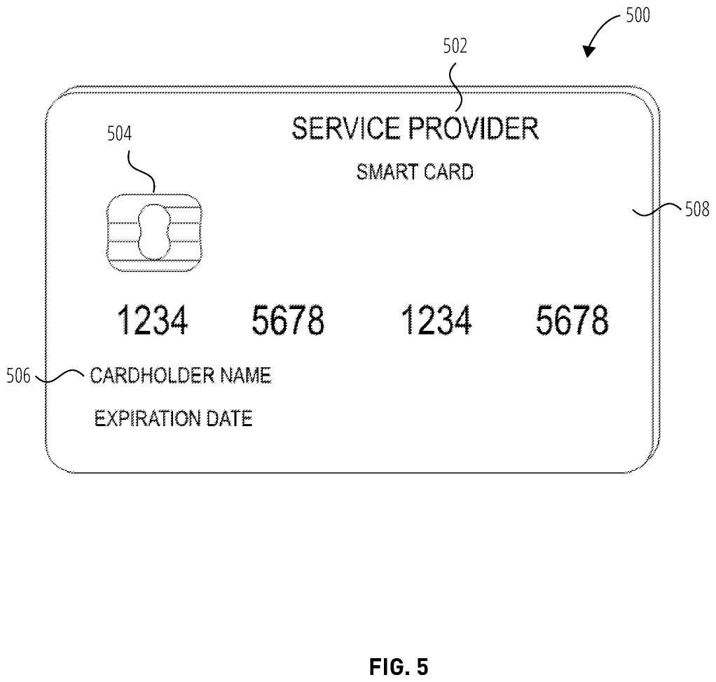

In embodiments, the computing device 102 may determine or detect that data can be automatically populated into one or more fields or forms, and first perform an authentication operation with a contactless card and the banking system 104. For example, the banking app and/or instructions may trigger or cause a prompt to be displayed on the display device for the user to provide the contactless card 106 to the computing device 102, e.g., bring the contactless card 106 within operating range of the computing device 102. The operating range may be defined by a communication range of a short-range communication interface configured to communicate with the contactless card 106. For example, the NFC operating range is approximately 10 centimeters or less. The contactless card 106 may be the same as and configured to communicate as the contactless card discussed in FIG. 5-FIG. 12, including exchanging information in a cryptogram that may be used to identify a user.

In embodiments, the computing device 102 may receive information and data from the contactless card 106 via one or more short-range communication exchanges with the card. The computing device 102 may be configured to further communicate with the banking system 104 the information received from the contactless card 106 via one or more exchanges. The information may be utilized by the banking system 104 to authenticate the user. If the user is not authenticated, operations to automatically populate data may cease. If the user is authenticated, the operations may determine the data and cause the data to automatically populate. For example, the computing device 102 may provide additional information relating to the one or more fields, e.g., an identifier of the webpage or mobile application, and identifiers of fields, to the banking system 104. The banking system 104 may utilize the additional information to determine the sensitive data to populate in the webpage or mobile application. The determined data may be provided back to the computing device 102 and populated into the corresponding fields.

In embodiments, the banking system 104 includes one or more computing devices, such as servers, networking equipment, and the like, configured to provide banking services for customers and perform the operations discussed herein. Embodiments are not limited to a certain configuration of the banking system 104. In embodiments, the banking system 104 is configured to receive the information from the computing devices 102, authenticate users, and determine the data to populate in the one or more fields of a webpage or mobile application.

The banking system 104 may authenticate the user by comparing the data received from the computing device 102 with stored data. As will be discussed in more detail below, the banking system 104 may ensure that the data from the contactless card can be decrypted utilizing shared keys and the information from the card matches stored data, e.g., a shared secret. Note that embodiments are not limited to authenticating the user in this manner, and in some instances, the user may provide a password, biometric input, etc. that may be used by the computing device 102 and/or banking system 104 to authenticate the user.

Once authenticated, the banking system may determine data to populate the field(s) or form. In the transaction example, the banking system 104 may determine a payment account based on the data received from the contactless card and/or information received from the computing device 102. Specifically, banking system 104 may perform a lookup in a secure database or data store to determine account information associated with user. The account information may include a credit card account number linked to a credit card account of the contactless card. Additional information may also be determined to populate in fields, e.g., a name of the user, an address of the user, a phone number of the user, a verification value associated with the account, an expiration date associated with the account, and so forth. This information may be provided back to the computing device 102 to populate in associated field(s).

In some instances, the banking system 104 may provide additional services for the user, including determining whether one or more options or optimal data exists to populate the field(s), e.g., whether using different account information to perform a transaction may be more beneficial to the user. For example, banking system 104 may use the data to identify the merchant and determine the optimal payment data. In one specific example, the banking system 104 may use a merchant identifier to determine the merchant is the airline. The banking system 104 may determine the user has a banking or credit account opened that will receive miles or points if it's used to perform the transaction. The banking system 104 may provide an option to the user of the computing device 102 to utilize the alternative account instead of the account associated with the contactless card to perform the transaction. The user may choose via the account via a window and/or information presented in a GUI on a display of the computing device 102, for example. The banking system 104 may provide a number of options (three or more accounts) for the user to select. Once the user makes the selection, the data corresponding to the selection may be populated into field(s).

The banking system 104 may make the determination to provide optional and/or optimal suggestions to the user based on one or more criteria, e.g., rewards, annual percentage rate (APR), current incentive programs (0% interest for 6 months), etc. Specifically, the banking system 104 may analyze one or more accounts associated with the user, including the account associated with the contactless card. The banking system 104 may store the account information for each user in a database or data store controlled by the banking system 104. To determine suggestions to the user, the banking system 104 may compare the features each of the accounts maintained by the bank, e.g., rewards, APR, incentive offers, etc. to determine which account may be optimal for the user. In some instances, the banking system 104 may communicate with third-party systems, e.g., other banking systems, airline systems, merchant systems, etc. to determine additional accounts or information that may be used to populate the field(s). Once the information is analyzed, the banking system 104 may communicate the options back to the user and the computing device 102.

For example, the banking system 104 may communicate all of the optional suggestions to the computing device 102. The optional suggestions may be a list of all of the available accounts to perform a transaction. The user may select one of the options, and based on the selection, the data may be populated and/or provided to the webpage or mobile application. In some instances, a response may be provided from computing device 102 to the banking system 104 of the user's selection, and the banking system 104 may send another communication to computing device 102 including the payment data to populate in the webpage or mobile application.

In embodiments, banking system 104 may rank the optional suggestions. The ranking may be based on one or more settings set by the user. For example, the banking system 104 may compare the accounts available to perform the purchase against preferences set by the user. The preferences may include a simple order accounts in which the user wants to use to perform the transaction. In other instances, the user may set different preferences, such as account having the highest rewards. In this example, banking system 104 may rank the accounts based on the rewards that they provide for the transaction. In embodiments, the ranking information may be provided to the computing device 102 and presented to the user. The user may make an informed decision based on the information presented.

In some instances, the banking system 104 may automatically choose one of the accounts based on the preferences set for the user. For example, the banking system 104 may select the first account available on a rank list provided by the user. In another example, the banking system 104 may select the account that will provide the greatest reward, e.g., most miles, highest percent back, incentive offers, etc. In some instances, the banking system 104 will perform one or more calculations to determine a similar value for each reward. For example, the banking system 104 may convert the miles to a monetary value, determine an estimated interest paid based on historical payments for the user, amount of money saved based on the incentive offer, etc. The banking system 104 may select the account that will provide the most monetary value to user, e.g., cash back or money/rewards earned. In the instances where the only singular information can be provided to the computing device 102 or the banking system 104 makes a selection of the optimal information, the banking system 104 may communicate the information to the computing device 102, and the computing device 102 may automatically populate the field(s) or form without user intervention, i.e., a user does not need to make a selection. Embodiments are not limited in this manner. Note that in some embodiments, one or more of the operations performed by the banking system 104 may be performed locally by the computing device 102. For example, the computing device 102 may store data locally that may be populate into the one or more fields. Embodiments are not limited in this manner.

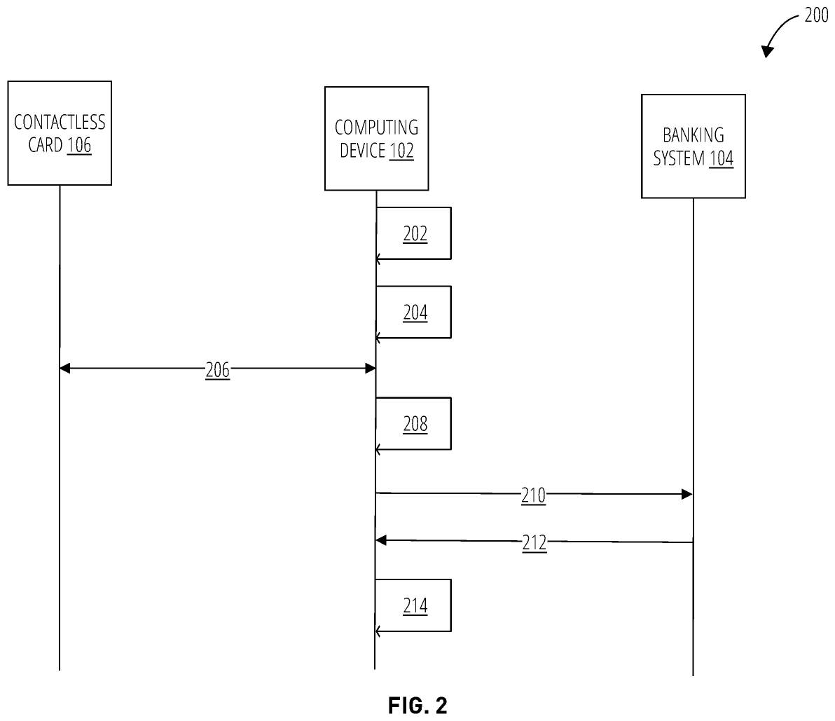

FIG. 2 illustrates an example sequence flow 200 that may be performed between a computing device 102, a contactless card 106, and a banking system 104. The operations discussed with respect to sequence flow 200 may be performed to determine sensitive data is required for a webpage or mobile application, perform an authentication operation to authenticate a user of a computing device and determine the sensitive data to populate for the webpage or application. As previously discussed, the data may be sensitive data required for one or more fields in a webpage or application.

At line 202, the sequence flow 200 includes the computing device 102 determining that data is required for a field or form in a website or a mobile device. For example, the computing device 102 executing instructions may receive a signal or indication that a field or form requiring data input is presented on a display to a user. The signal or indication may be received via a function call to a function of a banking app, a web browser, or the native third-party application executing on the computing device 102. In another example, the computing device 102 may execute a thread or function in operates as background process and detects when another application is presenting in a GUI one or more fields that requires data input. In some embodiments, the instructions may be implemented in a programming language, such as JavaScript (JS), or a scripting language like Python and may be called or execute to detect the data input requirement.

In embodiments, the instructions may automatically detect when the field(s) or form require sensitive data. The sensitive data may be any type of data that a user wants to keep secret or private. For example, the sensitive data may be personal information, banking information, medical information, and so forth. In one example discussed herein, the sensitive data may be transaction data used to perform a transaction. For example, a user may be utilizing a mobile application or a web browser to perform online shopping. A user may add the goods and/or services to an electronic shopping cart, i.e., a storing location, and then initiate a checkout process once they are done process. Typically, the app or web browser may present a checkout page in a graphical user interface (GUI) on the display and may request the user to provide information including shipping information, confirmation that the goods/services are correct, and billing/payment information. The computing device 102 may execute one or more instructions that analyze the names and types of elements (fields) presented to the user. The instructions may detect that an element is a field and perform a text-based analysis to detect the name indicates that sensitive data is required, e.g., the name of an element may be “AccountNumber,” indicating that a bank account number is to be entered into the field. The instructions may be implemented in a programming language such as JavaScript or Python such that when the user navigates to a page with fields or a form that detects the field identifier, field name, or XPath from the elements in the page.

Since the data is sensitive data and usage by someone other than the user may be harmful user, the system can verify the user is the owner of the data. Specifically, and at line 204, the sequence flow 200 includes performing an authentication operation to authenticate the user. In this example, the authentication operation is performed utilizing data stored on a contactless card. However, other authentication operations may be performed, e.g., entry of a passcode, biometric input, etc. In this example, the computing device 102 prompts the user to present the contactless card 106 to the computing device 102, e.g., bring the contactless card 106 within a communication range of the computing device 102. The computing device 102 may present in the GUI an indication to tap the contactless card 106 on the display of the computing device 102, ensuring that the card is brought within the communication of the computing device 102.

The indication to tap the card to the display may be displayed in the web browser or in the mobile application. For example, the computing device 102, including the mobile app or web browser, may provide the indication in the field typically used by the user to enter their payment information. The field may include a statement to “tap payment card on display”. In another example, the computing device 102 may cause a popup GUI to be presented to the user on the display, including the indication to tap the card to the display. The banking app and/or embedded instructions initialize and prepare for performing a short-range communication with the contactless card. For example, the computing device 102 may execute one or more instructions, including initializing one or more NFC exchanges, such as performing one or more NFC reads with the contactless card.

At line 206, the sequence flow 200 includes performing a short-range communication exchange with the contactless card 106. In embodiments, the short-range communication exchange may be an NFC exchange and include the computing device 102 and contactless card 106 performing an NFC initialization exchange to establish a connection, and one or more NFC read operations performed by the computing device 102 to read data from the contactless card 106. In embodiments, the contactless card 106 may be configured to receive power from the computing device 102 via electromagnetic energy; however, embodiments are not limited in this manner, and in some instances, the contactless card 106 may include its own power source, such as a battery.

In embodiments, the NFC exchange at line 206 includes the computing device 102 performing a read operation to receive an NFC payload, including information to identify the customer and perform the transaction. For example, the NFC payload may include a cryptogram having including authentication information including the one or more identification numbers, the counter, a version number, and a shared secret, and be encrypted using diversified keys, as discussed in FIG. 5-FIG. 12, by the contactless card 106. In some embodiments, the payload may include additional information, such as an unencrypted identifier that may identify the customer associated with the contactless card 106. Embodiments are not limited in this manner.

At line 208, the sequence flow 200 includes the computing device 102 receiving and processing the information from the contactless card 106. For example, the computing device 102 may prepare the information from the contactless card to communicate to the banking system 104 to perform an authentication operation, e.g., apply additional security operations (encryption), formatting the data, sending an indication to the banking system 104, etc. When different authentication operations are performed, the computing device 102 may process a passcode, biometric data, etc. to authenticate the user at this sequence step. In addition to processing the data from the contactless card and sending it to the banking system, the computing device 102 may determine and/or gather additional information with respect to the required sensitive data. For example, the computing device 102 may determine identifier(s) that may be used by the banking system 104 to identify the requested data (or fields), and the webpage/mobile application.

At line 210, the sequence flow 200 includes the computing device 102 communicating the information from the contactless card 106 and the additional information to the banking system 104. The contactless card information and identifier information may be communicated in one or more messages securely over one or more wireless and wired connections.

The banking system 104 may receive and process the information from the computing device 102. Specifically, the banking system 104 may confirm the identity of the customer based on the information received from the computing device 102 and the contactless card 106. For example, the banking system 104 may compare the information from the card to stored authenticated information to ensure that a shared secret matches an authenticated shared secret associated with the customer, for example.

If the user is authenticated, either by the banking system 104 confirming the contactless card information is correct or by the computing device 102 performing an authentication operation, the banking system 104 may determine the data required to fill out the field(s) or form, e.g., the data to send back to the computing device 102. For example, the banking system 104 may determine payment data and/or personal data to send to the computing device 102 to populate in the fields. As previously discussed, the payment data may include an account number associated with the contactless card 106, and the banking system 104 may perform a lookup in a database or data store to determine the number. The banking system 104 may perform similar operations to determine other data, e.g., personal data, medical data, other payment data, etc. For example, the banking system 104 may determine payment data for other accounts based on a benefit provided to the user based on one or more criteria. In some instances, the banking system 104 may determine and provide options or suggestions for the user to select to enter in one or more fields.

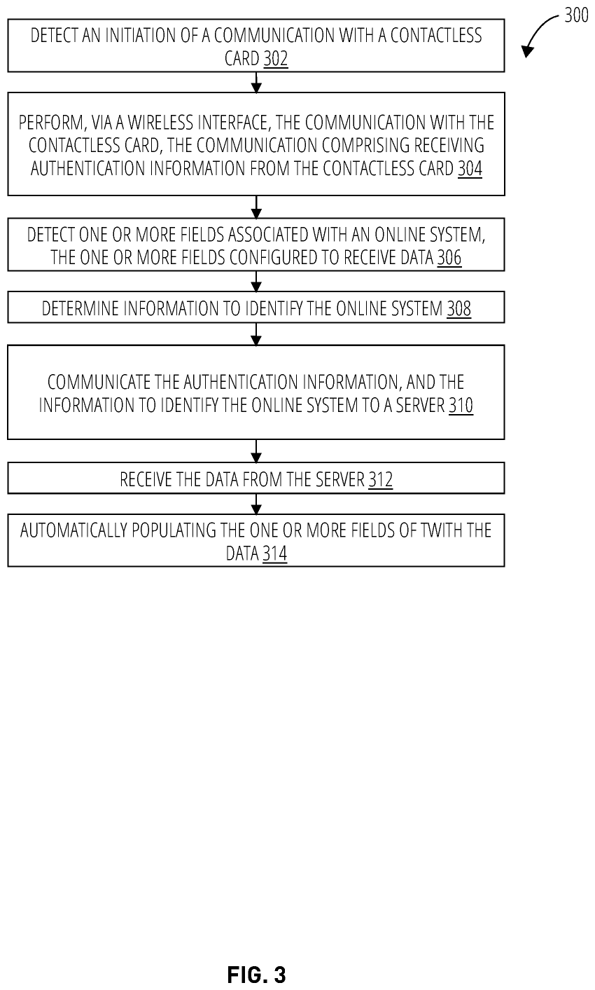

At line 212, the banking system 104 may send the data to the computing device 102 to automatically populate in one or more fields. At line 214, the data may be received by the computing device 102 and automatically entered into the field(s). As will be discussed in more detail with respect to FIG. 3, the computing device 102 may automatically populate the one or more fields based on the identifying information of the data received from the banking system 104, and the name or identifiers of the elements (fields) to be populated. If the banking system 104 provides one or more suggestions to the user, the user may be prompted to select one of the suggestions, and the data may be populated into one or more fields based on the user selection.

FIG. 3 illustrates a routine 300 that may be performed by a device, such as computing device 102, which may be a mobile device or the like, to automatically populate or provide data in a webpage or mobile application to perform an operation, such as perform an online transaction, submit a loan application, provide medical information, etc. In the illustrated routine 300, one or more of the operations may be performed by one or more apps or instructions executing on the computing device 102. In some instances, the data may be account data to perform transactions; however, embodiments are not limited in this manner. As previously discussed, the data may be personal data, medical data, and so forth, and used to perform the operations. Routine 300 begins with an exchange between the computing device 102 and a contactless card to authenticate a user. However, as discussed in FIG. 2, one or more operations may be performed prior to the exchange, e.g., the fields may be detected.

In block 302, the routine 300 detects initiation of a communication with a contactless card. In some instances, initiation of the communication with the contactless card may be result and based on a detection of one or more fields requiring sensitive data. The computing device 102 may prompt a user to bring the contactless card within a communication distance of by displaying a message or request. For example, the computing device 102 executing instructions may present on the display a message to tap the contactless card on the display. The message may be displayed in or around one or more fields requiring sensitive data in a webpage or mobile application or in a popup window on the display. The popup window may be triggered by instructions based on a detection of the one or more fields presented on the display that requires the user to enter sensitive data. The computing device 102 may detect one or more fields that require sensitive data based on names of the elements displayed, e.g., tags or labels for the fields. In some instances, instructions may be embedded in the webpage or mobile application itself, such that when a user navigates to the particular page, the instructions trigger the request for data and perform the authentication operation, e.g., bring a contactless card near the computing device 102.

In block 304, routine 300 performs, via a wireless interface, the communication with the contactless card, the communication includes receiving authentication information from the contactless card. The computing device 102 and the contactless card may exchange information in one or more messages, such as NFC data exchange format (NDEF) messages. The communication exchange with the contactless card may include receiving authentication information from the contactless card. In some embodiments, the computing device 102 may receive a payload including a cryptogram from the contactless card. As discussed herein, the cryptogram may include the authentication information including the one or more identification numbers, the counter, a version number, and a shared secret, and be encrypted using diversified keys. The cryptogram may be generated, encrypted, and communicated by the contactless card to the computing device 102. In embodiments, the payload may include additional information, such as an unencrypted identifier. The unencrypted identifier may be a customer identifier to identify a customer associated with and stored on the contactless card. Embodiments are not limited in this manner. The computing device 102 may utilize the information to conduct an authentication operation with a server or banking system.

In block 306, routine 300 detects or determines one or more fields of a webpage or mobile application of an online system. The one or more fields are configured to receive with data from a user or automatically populate. For example, the computing device 102 may execute one or more JavaScript or Java functions to identify the fields currently being displayed on a webpage or in a mobile application based on tags or labels of particular fields. In some instances, the computing device 102 may utilize the XPath query language to determine the fields (or elements) displayed on the webpage or mobile application. The result of an XPath query may return a name or label for each element on the webpage or mobile application. The text of the returned name(s) or label(s) may be analyzed to determine the specific data required. The names of the fields may be “AccountName,” “FirstName,” “LastName,” “ExpirationDate,” “Address,” and so forth. In some instances, the fields may be preprogrammed with known names, i.e., names known by the banking system or specified by the banking system. In other instances, the banking system may perform text analysis techniques on the name elements and use context clues to determine the specific data required, e.g., “AccNam” may be sufficiently similar to “AccountName.” Note that embodiments are not limited to utilize JavaScript and/or XPath to determine the names of the fields and other programming languages may be utilized to detect the elements or fields, such as a Python and get field function.

In block 308, routine 300 determines information to identify the online system. Specifically, embodiments include identifying the system hosting and/or providing the webpage or mobile application. For example, the online system may be a merchant system selling online goods and/or services, a banking system providing banking services, a medical provider system providing medical services, or the like. The information to identify the online system may be determined from the webpage or computing device 102 itself. For example, the identifier may be a web address or mobile application name. The information to identify the online system may also be used by the server and/or the banking system to determine the data for the fields.

In block 310, routine 300 communicates the authentication information and the information to identify the online system to a server. The server may be part of a banking system, and in some instances, there may be more than one server or computing system. The authentication information and information to identify the online system may be communicated via one or more secure connections. In some instances, the authentication information and identifying information may be communicated in different and/or separate messages. The computing device may also communicate information identify the field(s), e.g., the names of the elements.

The banking system including the server receiving the information may first authenticate the user based on the authentication information before determining and providing the data for the fields. If the authentication fails, the server will provide an indication to the computing device 102 of the failed authentication. In some instances, the banking system may require the customer to provide additional authentication information prior to populating the sensitive data, e.g., multi-factor authentication. For example, the banking system may send a request to the computing device 102 for the customer and/or the computing device 102 to provide additional authentication information. The computing device 102 including the website or mobile app may confirm authentication based on the customer logged into an account associated with the website or mobile app. In another example, the computing device 102 may receive the request and provide an indication on a display for the customer to provide additional authentication information, e.g., via a biometric sensor, entry of a credential/password, etc. In response to the request, the computing device 102 may provide the additional authentication information and a result as to whether the user is authenticated to the banking system. If authenticated, the server utilizes the information identifying the online system and the fields to determine data to populate. For example, the server may determine a merchant based on the identifying information by performing a lookup in a database. Once the merchant is identifying, the server may determine account or payment data that may be utilized by the merchant. The account data may be an account number that may be provided for a field on the webpage or mobile application. In embodiments, the account number may be the account number for the contactless card. As previously discussed, the server may perform operations to determine an optimal or different account that may be used to perform a transaction. For example, the server determines the merchant and determine whether using a different account may provide a benefit to the user, e.g., rewards, cashback, lower APR, incentive offer, etc.

In embodiments, the information identifying the online system may not be adequate to determine the data for the field(s). In some instances, the computing device 102 and the server may receive information identifying each field requiring data, e.g., the names of the elements, a field identifier, or the like. The information may identify a name field, a phone number field, an address field, an account field, an expiration data field, a CVV field, etc. As mentioned, techniques discussed herein may be applied to populate fields for data other than for transaction. For example, the required data may be to populate a loan application, and the fields may be for different data, e.g., a social security number field, an income field, a number of dependent fields, etc. Similarly, a medical system processing medical information may include medical-related fields, a health history field, a medicine field, an allergy field, etc.

The server may utilize the information identifying each field to determine data for each field, e.g., perform a lookup in a database or data store. For example, the server may utilize the name or identifier of the element (field) to determine corresponding data in a database, lookup an account number for a field named “AccountName”. The banking system including the server may store data relating to users in a secure and encrypted manner that may be used to provide the data to the fields. In some instances, the banking system may be configured to communicate and retrieve information from a third-party system, e.g., a medical provider system, another banking system, etc. A user may provide permission and/or opt into enabling the banking system to perform operations with other third-party systems.

In block 312, routine 300 receives the data from the server. Specifically, the computing device 102 may receive the data for the one or more fields from the banking system. The data may be communicated to the computing device 102 such that the computing device 102 may identify each particular piece of data corresponding to each field. For example, each piece of data may be labeled and/or identify with the label for a particular field, e.g., <Name> first last, <AccountNumber>#######, <PhoneNumber>#-###-###-####, etc. In embodiments, the identifiers may be same name or identifiers of the fields. The data may be sent to the computing device 102 in one or more communications or messages. In some embodiments, the label may be the same label or tag used by the webpage or mobile application to identify the field.

In some instances, the data may include one or more options for a particular piece of data. As previously discussed, the banking system may identify a number of accounts that may be used to perform a transaction and provide a list, and in some instances, a ranked list of the account options. The user may be prompted on the computing device 102 to select one of the options. Options may exist for different data as well. For example, the user may be associated with a number of phone numbers and may be prompted to select a phone number. Embodiments are not limited in this manner.

In block 314, the routine 300 includes automatically populating the one or more fields of the webpage or mobile application with the data. For example, the computing device 102 may receive the data from the server of the banking system and automatically populate it in the correct field(s) displayed on the webpage or mobile application. The computing device 102 may include one or more instructions, such as JavaScript or JS instructions, that post the data to a particular field based on the name, tag, or label on the field or element. As discussed, the computing device 102 may be configured to determine each element or field name. Similarly, the computing device 102 is configured to insert particular data into a corresponding element or field, e.g., inserting payment data into the payment element or field. The instructions may utilize the names of the fields determined above at block 306 to insert the corresponding language. For example, if the name of a field is “AccountNumber,” the function is configured to enter the payment data including the account number, into the field utilizing the name of “AccountNumber.” The computing device 102 including instructions determine the correct piece of data based on the identifiers communicated with the data from the banking system. Embodiments are not limited to this example, and each piece of data may be inserted in its corresponding field in the same manner.

Once all the data has been automatically populated into the field(s), the computing device 102 may proceed with perform the next operation or action, e.g., submitting the data to perform a transaction. In some instances, the computing device 102 may first ask the user to confirm the data via a popup window or the like. The computing device 102 may also rely on the user initiating the next operation, e.g., by activating a submit input or button.

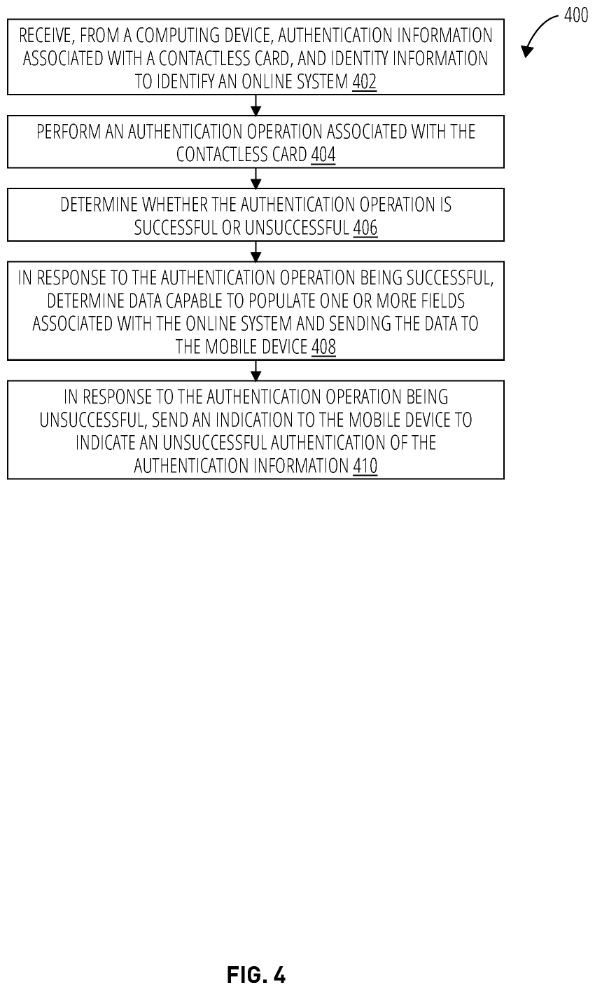

FIG. 4 illustrates an example routine 400 that may be performed by one or more servers of a system. In the illustrated example and following discussion, the server is incorporated into a banking system; however, embodiments are not limited in that manner. Routine 400 may be performed to authenticate a user and to determine data to populate in one or more fields.

In block 402, routine 400 includes receiving authentication information associated with a contactless card, and identity information to identify an online system. In some instances, the server may receive information to identify the one or more fields requiring data. The authentication information may include the information from a contactless card, including a cryptogram including the authentication information having one or more identification numbers, the counter, a version number, and a shared secret, and be encrypted using diversified keys. The cryptogram may be generated, encrypted, and communicated by the contactless card to the computing device 102 and then to the server by the computing device 102. In embodiments, the payload may include additional information, such as an unencrypted identifier. The unencrypted identifier may be a customer identifier to identify a customer associated with and stored on the contactless card. Embodiments are not limited in this manner. The computing device 102 may utilize the information to conduct an authentication operation with a server or banking system.

In block 404, routine 400 performs an authentication operation associated with the contactless card. For example, the banking system may determine whether that the authentication information from the contactless card can be decrypted based on one or more keys associated with the contactless card and stored on the banking system. In another example, the banking system may determine if at least a portion of the authentication information matches authenticated information stored on the banking system. For example, the banking system may determine if the shared secret from the contactless card matches a shared secret associated with the contactless card. The banking system may also confirm that the additional authentication information indicates that the customer is authentic, e.g., entered a password associated with the online merchant system, entered a correct credential on the customer's device, and so forth.

In block 406, routine 400 determines whether the authentication operation is successful or unsuccessful. In block 410, routine 400, in response to the authentication operation being unsuccessful, sends an indication to the computing device 102 to indicate an unsuccessful authentication of the authentication information.

block 408, routine 400, in response to the authentication operation being successful, determines data capable of populating one or more fields associated with the online system and sending the data to the computing device 102. For example, the server may utilize the information identifying the online system to identify a merchant. The server may then determine an account number associated with the user, and that may be used with the merchant and the online system. As mentioned, the server may receive information to identify each of the fields that require sensitive data. The server may determine the required data based on the name or identifier of the field, e.g., “AccountNumber,” corresponds to an account number to perform a transaction. The server may determine the data for each of the fields using the name or identifier of the fields, e.g., by performing a lookup in a database and/or communicating with a third-party system, as previously discussed.

The server may also determine one or more options or optimal data to provide for one or more fields. As discussed, the server may determine optimal data to return to the computing device based on user settings, e.g., most rewards, highest monetary value, etc. In some instances, the server may return a list of options, e.g., each account that can be used to perform the transaction. In some instances, the list may be a rank list based on the one or more criteria. The server may then send the data back to the computing device 102, and the computing device 102 may populate each of the fields with the corresponding data, as discussed in routine 300. If no options are provided to the user, the computing device may automatically populate the fields without user interaction. If options are provided to the user, the user may first select one of the options and then the data may be automatically populated into the fields. The following descriptions provides more detail with respect to the contactless card and perform the authentication operation utilizing the card.

FIG. 5 illustrates an example configuration of a contactless card 500, which may include a contactless card, a payment card, such as a credit card, debit card, or gift card, issued by a service provider as displayed as service provider indicia 502 on the front or back of the contactless card 500. In some examples, the contactless card 500 is not related to a payment card, and may include, without limitation, an identification card. In some examples, the contactless card may include a dual interface contactless payment card, a rewards card, and so forth. The contactless card 500 may include a substrate 508, which may include a single layer, or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 500 may have physical characteristics compliant with the ID-1 format of the ISO/IEC 7816 standard, and the contactless card may otherwise be compliant with the ISO/IEC 14443 standard. However, it is understood that the contactless card 500 according to the present disclosure may have different characteristics, and the present disclosure does not require a contactless card to be implemented in a payment card.

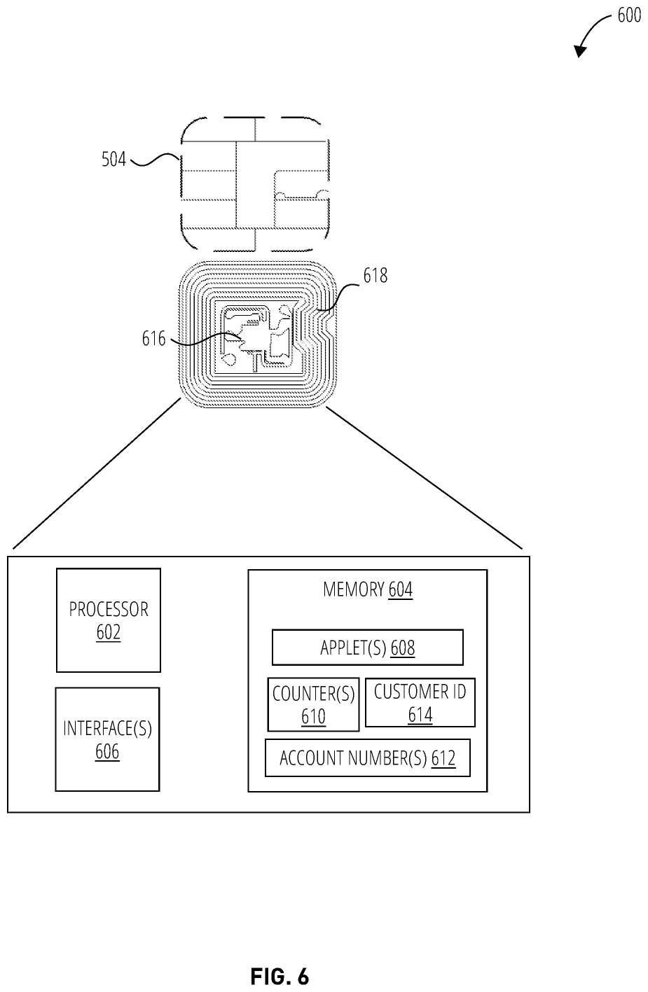

The contactless card 500 may also include identification information 506 displayed on the front and/or back of the card, and a contact pad 504. The contact pad 504 may include one or more pads and be configured to establish contact with another client device, such as an ATM, a user device, smartphone, laptop, desktop, or tablet computer via contactless cards. The contact pad may be designed in accordance with one or more standards, such as ISO/IEC 7816 standard, and enable communication in accordance with the EMV protocol. The contactless card 500 may also include processing circuitry, antenna and other components as will be further discussed in FIG. 6. These components may be located behind the contact pad 504 or elsewhere on the substrate 508, e.g. within a different layer of the substrate 508, and may electrically and physically coupled with the contact pad 504. The contactless card 500 may also include a magnetic strip or tape, which may be located on the back of the card (not shown in FIG. 5). The contactless card 500 may also include a Near-Field Communication (NFC) device coupled with an antenna capable of communicating via the NFC protocol. Embodiments are not limited in this manner.

As illustrated in FIG. 5, the contact pad 504 of contactless card 500 may include processing circuitry 616 for storing, processing, and communicating information, including a processor 602, a memory 604, and one or more interface(s) 606. It is understood that the processing circuitry 616 may contain additional components, including processors, memories, error and parity/CRC checkers, data encoders, anticollision algorithms, controllers, command decoders, security primitives and tamper proofing hardware, as necessary to perform the functions described herein.

The memory 604 may be a read-only memory, write-once read-multiple memory, or read/write memory, e.g., RAM, ROM, and EEPROM, and the contactless card 500 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 604 may be encrypted memory utilizing an encryption algorithm executed by the processor 602 to encrypted data.

The memory 604 may be configured to store one or more applet(s) 608, one or more counter(s) 610, a customer identifier 614, and the account number(s) 612, which may be virtual account numbers. The one or more applet(s) 608 may comprise one or more software applications configured to execute on one or more contactless cards, such as a Java® Card applet. However, it is understood that applet(s) 608 are not limited to Java Card applets, and instead may be any software application operable on contactless cards or other devices having limited memory. The one or more counter(s) 610 may comprise a numeric counter sufficient to store an integer. The customer identifier 614 may comprise a unique alphanumeric identifier assigned to a user of the 500, and the identifier may distinguish the user of the contactless card from other contactless card users. In some examples, the customer identifier 614 may identify both a customer and an account assigned to that customer and may further identify the contactless card 500 associated with the customer's account. As stated, the account number(s) 612 may include thousands of one-time use virtual account numbers associated with the contactless card 500. An applet(s) 608 of the contactless card 500 may be configured to manage the account number(s) 612 (e.g., to select an account number(s) 612, mark the selected account number(s) 612 as used, and transmit the account number(s) 612 to a mobile device for auto filling by an auto filling service.

The processor 602 and memory elements of the foregoing exemplary embodiments are described with reference to the contact pad 504, but the present disclosure is not limited thereto. It is understood that these elements may be implemented outside of the contact pad 504 or entirely separate from it, or as further elements in addition to processor 602 and memory 604 elements located within the contact pad 504.

In some examples, the contactless card 500 may comprise one or more antenna(s) 618. The one or more antenna(s) 618 may be placed within the contactless card 500 and around the processing circuitry 616 of the contact pad 504. For example, the one or more antenna(s) 618 may be integral with the processing circuitry 616 and the one or more antenna(s) 618 may be used with an external booster coil. As another example, the one or more antenna(s) 618 may be external to the contact pad 504 and the processing circuitry 616.

In an embodiment, the coil of contactless card 500 may act as the secondary of an air core transformer. The terminal may communicate with the contactless card 500 by cutting power or amplitude modulation. The contactless card 101 may infer the data transmitted from the terminal using the gaps in the contactless card's power connection, which may be functionally maintained through one or more capacitors. The contactless card 500 may communicate back by switching a load on the contactless card's coil or load modulation. Load modulation may be detected in the terminal's coil through interference. More generally, using the antenna(s) 618, processor 602, and/or the memory 604, the contactless card 101 provides a communications interface to communicate via NFC, Bluetooth, and/or Wi-Fi communications.

As explained above, contactless card 500 may be built on a software platform operable on smart cards or other devices having limited memory, such as JavaCard, and one or more or more applications or applets may be securely executed. Applet(s) 608 may be added to contactless cards to provide a one-time password (OTP) for multifactor authentication (MFA) in various mobile application-based use cases. Applet(s) 608 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 608 may be configured to encode the OTP as an NDEF type 4 well known type text tag. In some examples, NDEF messages may comprise one or more records. The applet(s) 608 may be configured to add one or more static tag records in addition to the OTP record.

In some examples, the one or more applet(s) 608 may be configured to emulate an RFID tag. The RFID tag may include one or more polymorphic tags. In some examples, each time the tag is read, different cryptographic data is presented that may indicate the authenticity of the contactless card. Based on the one or more applet(s) 608, an NFC read of the tag may be processed, the data may be transmitted to a server, such as a server of a banking system, and the data may be validated at the server.

In some examples, the contactless card 500 and server may include certain data such that the card may be properly identified. The contactless card 500 may include one or more unique identifiers (not pictured). Each time a read operation takes place, the counter(s) 610 may be configured to increment. In some examples, each time data from the contactless card 500 is read (e.g., by a mobile device), the counter(s) 610 is transmitted to the server for validation and determines whether the counter(s) 610 are equal (as part of the validation) to a counter of the server.

The one or more counter(s) 610 may be configured to prevent a replay attack. For example, if a cryptogram has been obtained and replayed, that cryptogram is immediately rejected if the counter(s) 610 has been read or used or otherwise passed over. If the counter(s) 610 has not been used, it may be replayed. In some examples, the counter that is incremented on the card is different from the counter that is incremented for transactions. The contactless card 101 is unable to determine the application transaction counter(s) 610 since there is no communication between applet(s) 608 on the contactless card 500.

In some examples, the counter(s) 610 may get out of sync. In some examples, to account for accidental reads that initiate transactions, such as reading at an angle, the counter(s) 610 may increment but the application does not process the counter(s) 610. In some examples, when the mobile device 10 is woken up, NFC may be enabled and the device 110 may be configured to read available tags, but no action is taken responsive to the reads.

To keep the counter(s) 610 in sync, an application, such as a background application, may be executed that would be configured to detect when the mobile device 110 wakes up and synchronize with the server of a banking system indicating that a read that occurred due to detection to then move the counter value forward. In other examples, Hashed One Time Password may be utilized such that a window of mis-synchronization may be accepted. For example, if within a threshold of 10, the counter(s) 610 may be configured to move forward. But if within a different threshold number, for example within 10 or 900, a request for performing re-synchronization may be processed which requests via one or more applications that the user tap, gesture, or otherwise indicate one or more times via the user's device. If the counter(s) 610 increases in the appropriate sequence, then it possible to know that the user has done so.

The key diversification technique described herein with reference to the counter(s) 610, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 500, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 500. By using the key diversification process, one or more keys may be derived from a master key based upon uniquely identifiable information for each entity that requires a key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 101 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

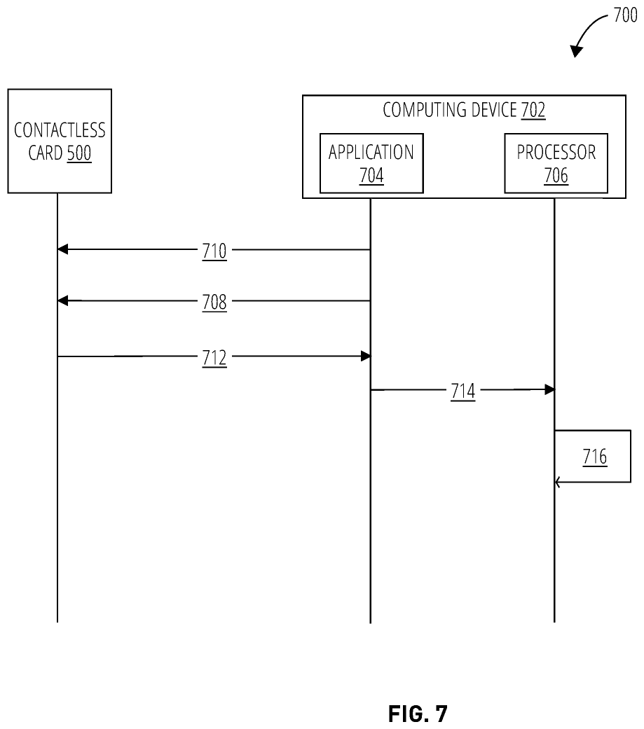

FIG. 7 is a sequence flow 700 illustrating an example sequence for providing authenticated access according to one or more embodiments of the present disclosure. Sequence flow 700 may include contactless card 500 and computing device 702, which may include an application 704 and processor 706.

At line 710, the application 704 communicates with the contactless card 500 (e.g., after being brought near the contactless card 500). Communication between the application 704 and the contactless card 500 may involve the contactless card 500 being sufficiently close to a card reader (not shown) of the computing device 702 to enable NFC data transfer between the application 704 and the contactless card 500.

At line 708, after communication has been established between computing device 702 and contactless card 500, contactless card 500) generates a message authentication code (MAC) cryptogram. In some examples, this may occur when the contactless card 500 is read by the application 704. In particular, this may occur upon a read, such as an NFC read, of a near field data exchange (NDEF) tag, which may be created in accordance with the NFC Data Exchange Format. For example, a reader application, such as application 704, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 500 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string). In some examples, application 704 may be configured to transmit a request to contactless card 500, the request comprising an instruction to generate a MAC cryptogram.

At line 712, the 500 sends the MAC cryptogram to the application 704. In some examples, the transmission of the MAC cryptogram occurs via NFC, however, the present disclosure is not limited thereto. In other examples, this communication may occur via Bluetooth, Wi-Fi, or other means of wireless data communication. At line 714, the application 704 communicates the MAC cryptogram to the processor 706.

At line 716, the processor 706 verifies the MAC cryptogram pursuant to an instruction from the application 122. For example, the MAC cryptogram may be verified, as explained below. In some examples, verifying the MAC cryptogram may be performed by a device other than computing device 702, such as a server of a banking system in data communication with the computing device 702. For example, processor 706 may output the MAC cryptogram for transmission to the server of the banking system, which may verify the MAC cryptogram. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

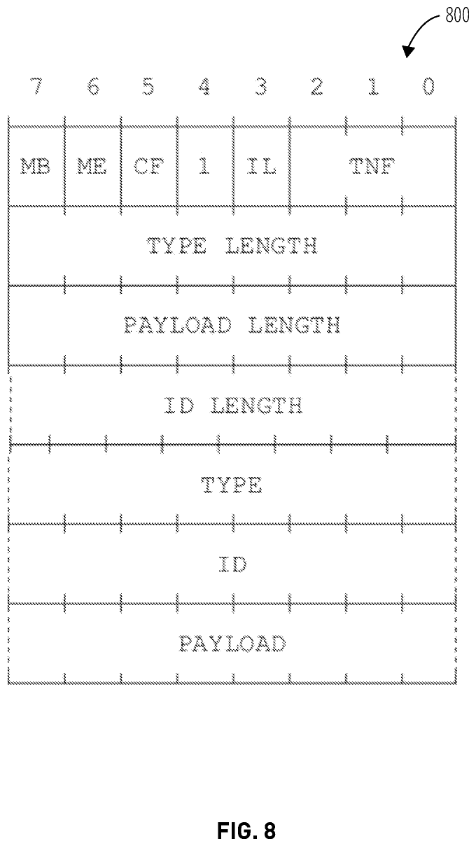

FIG. 8 illustrates an NDEF short-record layout (SR=1) data structure 800 according to an example embodiment. One or more applets may be configured to encode the OTP as an NDEF type 4 well known type text tag. In some examples, NDEF messages may comprise one or more records. The applets may be configured to add one or more static tag records in addition to the OTP record. Exemplary tags include, without limitation, Tag type: well-known type, text, encoding English (en); Applet ID: D2760000850101; Capabilities: read-only access; Encoding: the authentication message may be encoded as ASCII hex; type-length-value (TLV) data may be provided as a personalization parameter that may be used to generate the NDEF message. In an embodiment, the authentication template may comprise the first record, with a well-known index for providing the actual dynamic authentication data.

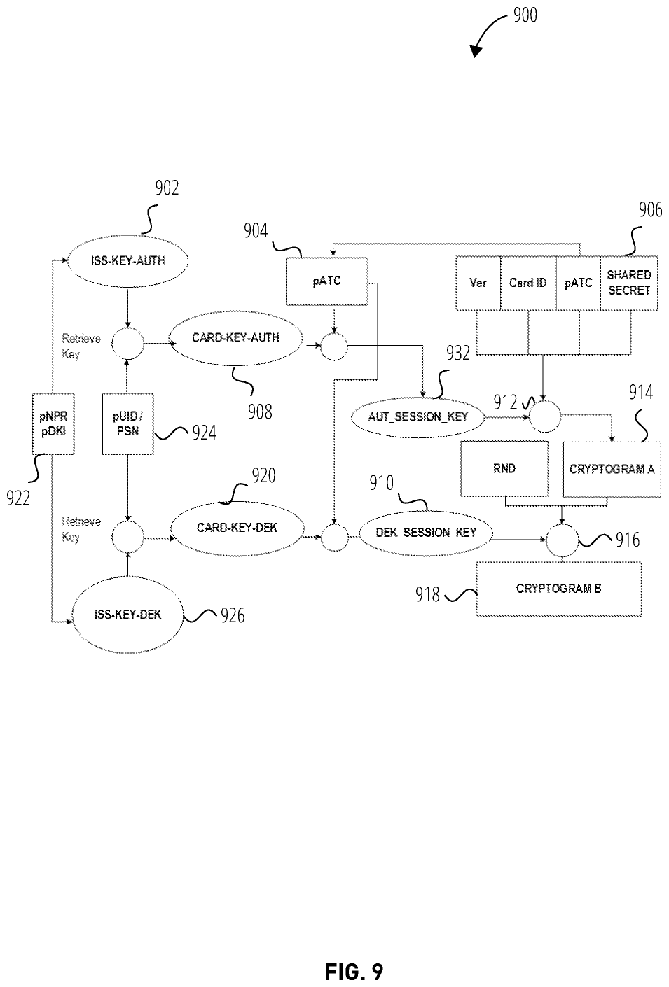

FIG. 9 illustrates a diagram of a system key system 900 configured to implement one or more embodiments of the present disclosure. As explained below, during the contactless card creation process, two cryptographic keys may be assigned uniquely for each card. The cryptographic keys may comprise symmetric keys which may be used in both encryption and decryption of data. Triple DES (3DES) algorithm may be used by EMV and it is implemented by hardware in the contactless card. By using a key diversification process, one or more keys may be derived from a master key based upon uniquely identifiable information for each entity that requires a key.

Regarding master key management, two issuer master keys 902, 926 may be required for each part of the portfolio on which the one or more applets is issued. For example, the first master key 902 may comprise an Issuer Cryptogram Generation/Authentication Key (Iss-Key-Auth) and the second master key 926 may comprise an Issuer Data Encryption Key (Iss-Key-DEK). As further explained herein, two issuer master keys 902, 926 are diversified into card master keys 908, 920, which are unique for each card. In some examples, a network profile record ID (pNPR) 522 and derivation key index (pDKI) 924, as back office data, may be used to identify which Issuer Master Keys 902, 926 to use in the cryptographic processes for authentication. The system performing the authentication may be configured to retrieve values of pNPR 922 and pDKI 924 for a contactless card at the time of authentication.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 908 and Card-Key-Dek 920). The session keys (Aut-Session-Key 932 and DEK-Session-Key 910) may be generated by the one or more applets and derived by using the application transaction counter (pATC) 904 with one or more algorithms. To fit data into the one or more algorithms, only the 2 low order bytes of the 4-byte pATC 904 is used. In some examples, the four byte session key derivation method may comprise: F1:=PATC(lower 2 bytes)∥‘F0’∥‘00’∥PATC (four bytes) F1:=PATC(lower 2 bytes)∥‘0F’∥‘00’∥PATC (four bytes) SK:={(ALG (MK) [F1])∥ALG (MK) [F2]}, where ALG may include 3DES ECB and MK may include the card unique derived master key.

As described herein, one or more MAC session keys may be derived using the lower two bytes of pATC 904 counter. At each tap of the contactless card, pATC 904 is configured to be updated, and the card master keys Card-Key-AUTH and Card-Key-DEK 920 are further diversified into the session keys Aut-Session-Key 932 and DEK-Session-KEY 910. pATC 904 may be initialized to zero at personalization or applet initialization time. In some examples, the pATC counter 904 may be initialized at or before personalization and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In some examples, only the authentication data and an 8-byte random number followed by MAC of the authentication data may be included. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 932. The data specified in cryptogram may be processed with javacard.signature method: ALG_DES_MAC8_ISO9797_1_M2_ALG3 to correlate to EMV ARQC verification methods. The key used for this computation may comprise a session key AUT-Session-Key 932, as explained above. As explained above, the low order two bytes of the counter may be used to diversify for the one or more MAC session keys. As explained below, AUT-Session-Key 932 may be used to MAC data 906, and the resulting data or cryptogram A 914 and random number RND may be encrypted using DEK-Session-Key 910 to create cryptogram B or output 918 sent in the message.

In some examples, one or more HSM commands may be processed for decrypting such that the final 16 (binary, 32 hex) bytes may comprise a 3DES symmetric encrypting using CBC mode with a zero IV of the random number followed by MAC authentication data. The key used for this encryption may comprise a session key DEK-Session-Key 910 derived from the Card-Key-DEK 920. In this case, the ATC value for the session key derivation is the least significant byte of the counter pATC 904.

The format below represents a binary version example embodiment. Further, in some examples, the first byte may be set to ASCII ‘A’.

Message Format

| | | | | |
|---|---|---|---|---|
| 1 | 2 | 4 | 8 | 8 |
| 0x43 (Message Type ‘A’) | Version | pATC | RND | Cryptogram A (MAC) |

| | |
|---|---|
| Cryptogram A (MAC) | 8 bytes |

Mac of

| | | | | |
|---|---|---|---|---|
| 2 | 8 | 4 | 4 | 18 bytes input data |
| Version | pUID | pATC | Shared Secret | |

Message Format

| | | | |
|---|---|---|---|
| 1 | 2 | 4 | 16 |
| 0x43 (Message Type ‘A’) | Version | pATC | Cryptogram B |
| Cryptogram A (MAC) | 8 bytes | | |

MAC of

| | | | | |
|---|---|---|---|---|
| 2 | 8 | 4 | 4 | 18 bytes input data |
| Version | pUID | pATC | Shared Secret | |

| Cryptogram B | 16 |
|---|---|
| Sym Encryption of | |
| 8 | 8 |
| RND | Cryptogram A |

Another exemplary format is shown below. In this example, the tag may be encoded in hexadecimal format.

Message Format

| | | | | |
|---|---|---|---|---|
| 2 | 8 | 4 | 8 | 8 |
| Version | pUID | pATC | RND | Cryptogram A (MAC) |

8 bytes

| | | | | |
|---|---|---|---|---|
| 8 | 8 | 4 | 4 | 18 bytes input data |
| pUID | pUID | pATC | Shared Secret | |

Message Format

| 2 | 8 | 4 | 16 |
|---|---|---|---|
| Version | pUID | pATC | Cryptogram B |
| 8 bytes | | | |

| 8 | | 4 | 4 | 18 bytes input data |
|---|---|---|---|---|
| pUID | pUID | pATC | Shared Secret | |

| Cryptogram B | 16 |
|---|---|
| Sym Encryption of | |
| 8 | 8 |
| RND | Cryptogram A |

The UID field of the received message may be extracted to derive, from master keys Iss-Key-AUT 902 and Iss-Key-DEK 926, the card master keys (Card-Key-Auth 908 and Card-Key-DEK 920) for that particular card. Using the card master keys (Card-Key-Auth 908 and Card-Key-DEK 920), the counter (pATC) field of the received message may be used to derive the session keys (Aut-Session-Key 932 and DEK-Session-Key 910) for that particular card. Cryptogram B 918 may be decrypted using the DEK-Session-KEY, which yields cryptogram A 914 and RND, and RND may be discarded. The UID field may be used to look up the shared secret of the contactless card which, along with the Ver, UID, and pATC fields of the message, may be processed through the cryptographic MAC using the re-created Aut-Session-Key to create a MAC output, such as MAC′. If MAC′ is the same as cryptogram A 914, then this indicates that the message decryption and MAC checking have all passed. Then the pATC may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 932. The input data 906 may take the following form: Version (2), pUID (8), pATC (4), Shared Secret (4). In some examples, the numbers in the brackets may comprise length in bytes. In some examples, the shared secret may be generated by one or more random number generators which may be configured to ensure, through one or more secure processes, that the random number is unpredictable. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x′80′ byte to the end of input data and 0x′00′ bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC (Block chaining) mode of the symmetric encryption algorithm. This allows the “scrambling” from block to block without having to pre-establish either a fixed or dynamic IV.

By including the application transaction counter (pATC) as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some examples, the pATC may start at zero and be updated by 1 each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and the authenticated may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 912, data 906 is processed through the MAC using Aut-Session-Key 932 to produce MAC output (cryptogram A) 914, which is encrypted.

In order to provide additional protection against brute force attacks exposing the keys on the card, it is desirable that the MAC cryptogram 914 be enciphered. In some examples, data or cryptogram A 914 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 910. In the encryption operation 916, data or cryptogram A 914 and RND are processed using DEK-Session-Key 510 (deleted) to produce encrypted data, cryptogram B 918. The data 914 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0x′0000000000000000′ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

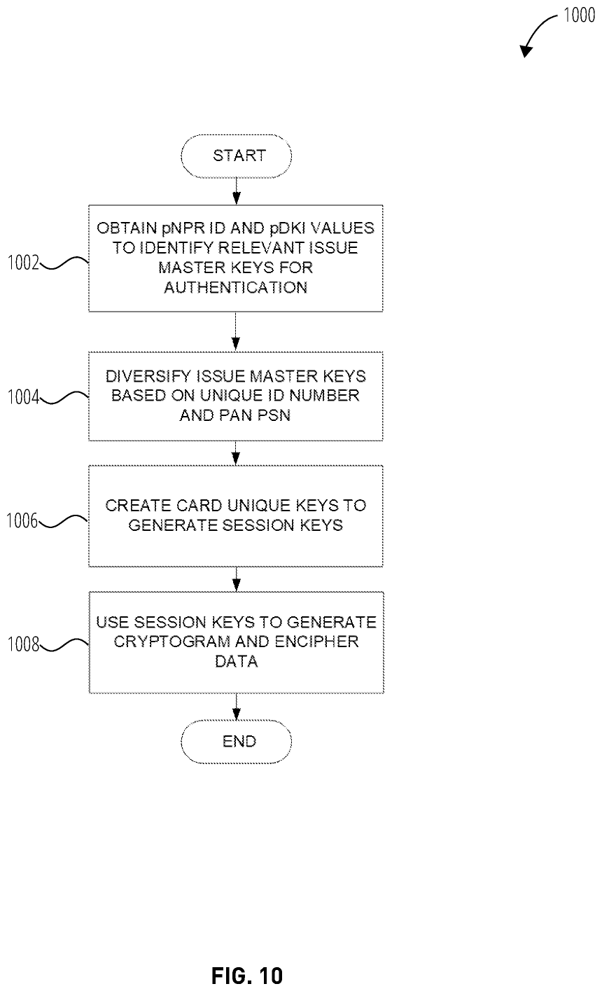

FIG. 10 illustrates a method routine 1000 for generating a cryptogram. For example, at block 1002, a network profile record ID (pNPR) and derivation key index (pDKI) may be used to identify which Issuer Master Keys to use in the cryptographic processes for authentication. In some examples, the method may include performing the authentication to retrieve values of pNPR and pDKI for a contactless card at the time of authentication.

At block 1004, Issuer Master Keys may be diversified by combining them with the card's unique ID number (pUID) and the PAN sequence number (PSN) of one or more applets, for example, a payment applet.

At block 1006, Card-Key-Auth and Card-Key-DEK (unique card keys) may be created by diversifying the Issuer Master Keys to generate session keys which may be used to generate a MAC cryptogram.

At block 1008, the keys used to generate the cryptogram and encipher the data in the one or more applets may comprise the session keys of block 930 based on the card unique keys (Card-Key-Auth and Card-Key-DEK). In some examples, these session keys may be generated by the one or more applets and derived by using pATC, resulting in session keys Aut-Session-Key and DEK-Session-Key.

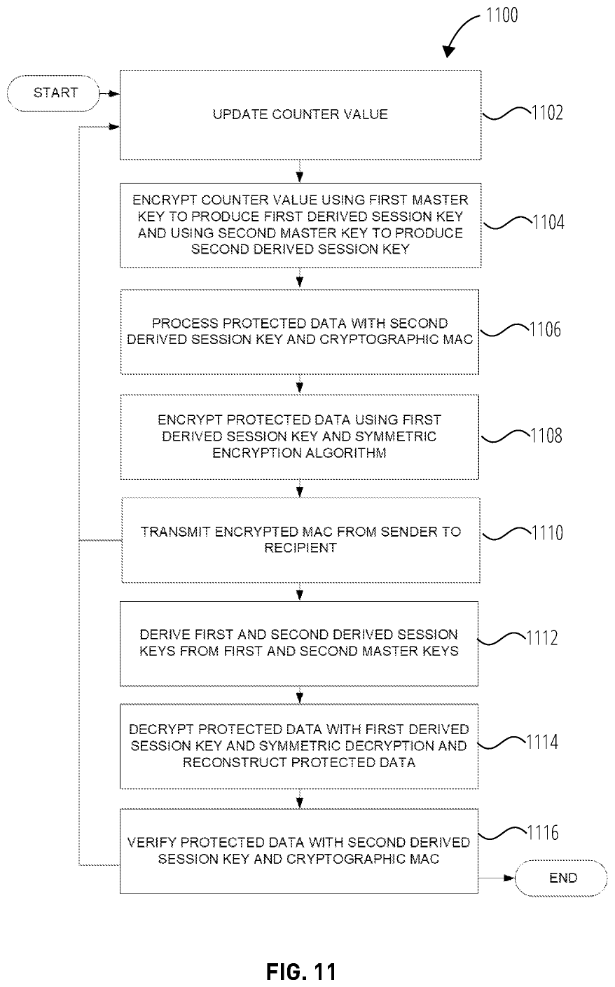

FIG. 11 depicts an exemplary process routine 1100 illustrating key diversification according to one example. Initially, a sender and the recipient may be provisioned with two different master keys. For example, a first master key may comprise the data encryption master key, and a second master key may comprise the data integrity master key. The sender has a counter value, which may be updated at block 1102, and other data, such as data to be protected, which it may secure share with the recipient.

At block 1104, the counter value may be encrypted by the sender using the data encryption master key to produce the data encryption derived session key, and the counter value may also be encrypted by the sender using the data integrity master key to produce the data integrity derived session key. In some examples, a whole counter value or a portion of the counter value may be used during both encryptions.

In some examples, the counter value may not be encrypted. In these examples, the counter may be transmitted between the sender and the recipient in the clear, i.e., without encryption.

At block 1106, the data to be protected is processed with a cryptographic MAC operation by the sender using the data integrity session key and a cryptographic MAC algorithm. The protected data, including plaintext and shared secret, may be used to produce a MAC using one of the session keys (AUT-Session-Key).

At block 1108, the data to be protected may be encrypted by the sender using the data encryption derived session key in conjunction with a symmetric encryption algorithm. In some examples, the MAC is combined with an equal amount of random data, for example each 8 bytes long, and then encrypted using the second session key (DEK-Session-Key).

At block 1110, the encrypted MAC is transmitted, from the sender to the recipient, with sufficient information to identify additional secret information (such as shared secret, master keys, etc.), for verification of the cryptogram.

At block 1112, the recipient uses the received counter value to independently derive the two derived session keys from the two master keys as explained above.

At block 1114, the data encryption derived session key is used in conjunction with the symmetric decryption operation to decrypt the protected data. Additional processing on the exchanged data will then occur. In some examples, after the MAC is extracted, it is desirable to reproduce and match the MAC. For example, when verifying the cryptogram, it may be decrypted using appropriately generated session keys. The protected data may be reconstructed for verification. A MAC operation may be performed using an appropriately generated session key to determine if it matches the decrypted MAC. As the MAC operation is an irreversible process, the only way to verify is to attempt to recreate it from source data.

At block 1116, the data integrity derived session key is used in conjunction with the cryptographic MAC operation to verify that the protected data has not been modified.

Some examples of the methods described herein may advantageously confirm when a successful authentication is determined when the following conditions are met. First, the ability to verify the MAC shows that the derived session key was proper. The MAC may only be correct if the decryption was successful and yielded the proper MAC value. The successful decryption may show that the correctly derived encryption key was used to decrypt the encrypted MAC. Since the derived session keys are created using the master keys known only to the sender (e.g., the transmitting device) and recipient (e.g., the receiving device), it may be trusted that the contactless card which originally created the MAC and encrypted the MAC is indeed authentic. Moreover, the counter value used to derive the first and second session keys may be shown to be valid and may be used to perform authentication operations.

Thereafter, the two derived session keys may be discarded, and the next iteration of data exchange will update the counter value (returning to block 1102) and a new set of session keys may be created (at block 1110). In some examples, the combined random data may be discarded.

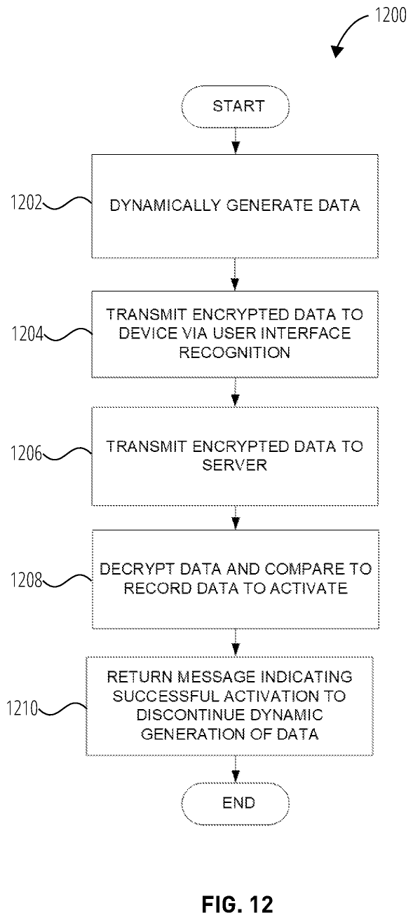

FIG. 12 illustrates a sequence flow 700 for card activation according to an example embodiment. For example, card activation may be completed by a system including a card, a device, and one or more servers. The contactless card, device, and one or more servers may reference same or similar components that were previously explained a, such as contactless card 500, computing device 702, and a server.

In block 1202, the card may be configured to dynamically generate data. In some examples, this data may include information such as an account number, card identifier, card verification value, or phone number, which may be transmitted from the card to the device. In some examples, one or more portions of the data may be encrypted via the systems and methods disclosed herein.

In block 1204, one or more portions of the dynamically generated data may be communicated to an application of the device via NFC or other wireless communication. For example, a tap of the card proximate to the device may allow the application of the device to read the one or more portions of the data associated with the contactless card. In some examples, if the device does not comprise an application to assist in activation of the card, the tap of the card may direct the device or prompt the customer to a software application store to download an associated application to activate the card. In some examples, the user may be prompted to sufficiently gesture, place, or orient the card towards a surface of the device, such as either at an angle or flatly placed on, near, or proximate the surface of the device. Responsive to a sufficient gesture, placement and/or orientation of the card, the device may proceed to transmit the one or more encrypted portions of data received from the card to the one or more servers.

In block 1206, the one or more portions of the data may be communicated to one or more servers, such as a card issuer server. For example, one or more encrypted portions of the data may be transmitted from the device to the card issuer server for activation of the card.

In block 1208, the one or more servers may decrypt the one or more encrypted portions of the data via the systems and methods disclosed herein. For example, the one or more servers may receive the encrypted data from the device and may decrypt it in order to compare the received data to record data accessible to the one or more servers. If a resulting comparison of the one or more decrypted portions of the data by the one or more servers yields a successful match, the card may be activated. If the resulting comparison of the one or more decrypted portions of the data by the one or more servers yields an unsuccessful match, one or more processes may take place. For example, responsive to the determination of the unsuccessful match, the user may be prompted to tap, swipe, or wave gesture the card again. In this case, there may be a predetermined threshold comprising a number of attempts that the user is permitted to activate the card. Alternatively, the user may receive a notification, such as a message on his or her device indicative of the unsuccessful attempt of card verification and to call, email or text an associated service for assistance to activate the card, or another notification, such as a phone call on his or her device indicative of the unsuccessful attempt of card verification and to call, email or text an associated service for assistance to activate the card, or another notification, such as an email indicative of the unsuccessful attempt of card verification and to call, email or text an associated service for assistance to activate the card.

In block 1210, the one or more servers may transmit a return message based on the successful activation of the card. For example, the device may be configured to receive output from the one or more servers indicative of a successful activation of the card by the one or more servers. The device may be configured to display a message indicating successful activation of the card. Once the card has been activated, the card may be configured to discontinue dynamically generating data so as to avoid fraudulent use. In this manner, the card may not be activated thereafter, and the one or more servers are notified that the card has already been activated.

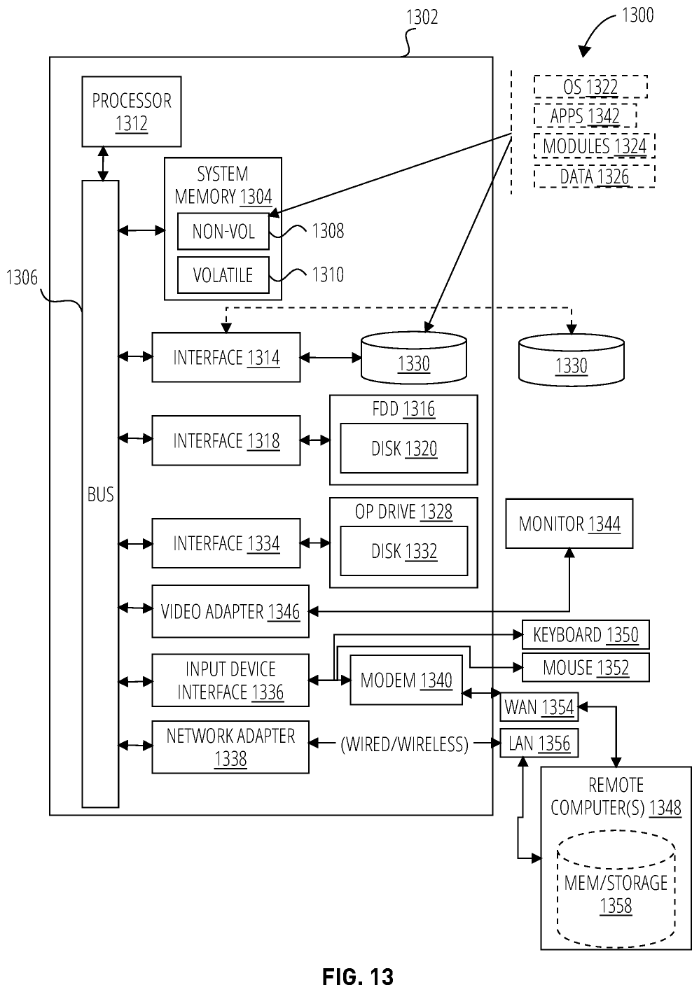

FIG. 13 illustrates an embodiment of an exemplary computer architecture 1300 suitable for implementing various embodiments as previously described. In one embodiment, the computer architecture 1300 may include or be implemented as part of systems discussed herein.

As used in this application, the terms “system” and “component” are intended to refer to a computer-related entity, either hardware, a combination of hardware and software, software, or software in execution, examples of which are provided by the exemplary computing computer architecture 1300. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1300 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1300.

As shown in FIG. 13, the computing architecture 100 includes a processor 1312, a system memory 1304 and a system bus 1306. The processor 1312 can be any of various commercially available processors.

The system bus 1306 provides an interface for system components including, but not limited to, the system memory 1304 to the processor 1312. The system bus 1306 can be any of several types of bus structure that may further interconnect to a memory bus (with or without a memory controller), a peripheral bus, and a local bus using any of a variety of commercially available bus architectures. Interface adapters may connect to system bus 1306 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1304 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 13, the system memory 1304 can include non-volatile 1308 and/or volatile 1310. A basic input/output system (BIOS) can be stored in the non-volatile 1308.

The computer 1302 may include various types of computer-readable storage media in the form of one or more lower speed memory units, including an internal (or external) hard disk drive 1330, a magnetic disk drive 1316 to read from or write to a removable magnetic disk 1320, and an optical disk drive 1328 to read from or write to a removable optical disk 1332 (e.g., a CD-ROM or DVD). The hard disk drive 1330, magnetic disk drive 1316 and optical disk drive 1328 can be connected to system bus 1306 the by an HDD interface 1314, and FDD interface 1318 and an optical disk drive interface 1334, respectively. The HDD interface 1314 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 1308, and volatile 1310, including an operating system 1322, one or more applications 1342, other program modules 1324, and program data 1326. In one embodiment, the one or more applications 1342, other program modules 1324, and program data 1326 can include, for example, the various applications and/or components of the systems discussed herein.

A user can enter commands and information into the computer 1302 through one or more wire/wireless input devices, for example, a keyboard 1350 and a pointing device, such as a mouse 1352. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 1312 through an input device interface 1336 that is coupled to the system bus 1306 but can be connected by other interfaces such as a parallel port, IEEE 1394 serial port, a game port, a USB port, an IR interface, and so forth.

A monitor 1344 or other type of display device is also connected to the system bus 1306 via an interface, such as a video adapter 1346. The monitor 1344 may be internal or external to the computer 1302. In addition to the monitor 1344, a computer typically includes other peripheral output devices, such as speakers, printers, and so forth.

The computer 1302 may operate in a networked environment using logical connections via wire and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all the elements described relative to the computer 1302, although, for purposes of brevity, only a memory and/or storage device 1358 is illustrated. The logical connections depicted include wire/wireless connectivity to a local area network 1356 and/or larger networks, for example, a wide area network 1354. Such LAN and WAN networking environments are commonplace in offices and companies, and facilitate enterprise-wide computer networks, such as intranets, all of which may connect to a global communications network, for example, the Internet.

When used in a local area network 1356 networking environment, the computer 1302 is connected to the local area network 1356 through a wire and/or wireless communication network interface or network adapter 1338. The network adapter 1338 can facilitate wire and/or wireless communications to the local area network 1356, which may also include a wireless access point disposed thereon for communicating with the wireless functionality of the network adapter 1338.

When used in a wide area network 1354 networking environment, the computer 1302 can include a modem 1340, or is connected to a communications server on the wide area network 1354 or has other means for establishing communications over the wide area network 1354, such as by way of the Internet. The modem 1340, which can be internal or external and a wire and/or wireless device, connects to the system bus 1306 via the input device interface 1336. In a networked environment, program modules depicted relative to the computer 1302, or portions thereof, can be stored in the remote memory and/or storage device 1358. It will be appreciated that the network connections shown are exemplary and other means of establishing a communications link between the computers can be used.

The computer 1302 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference embodiments discussed herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

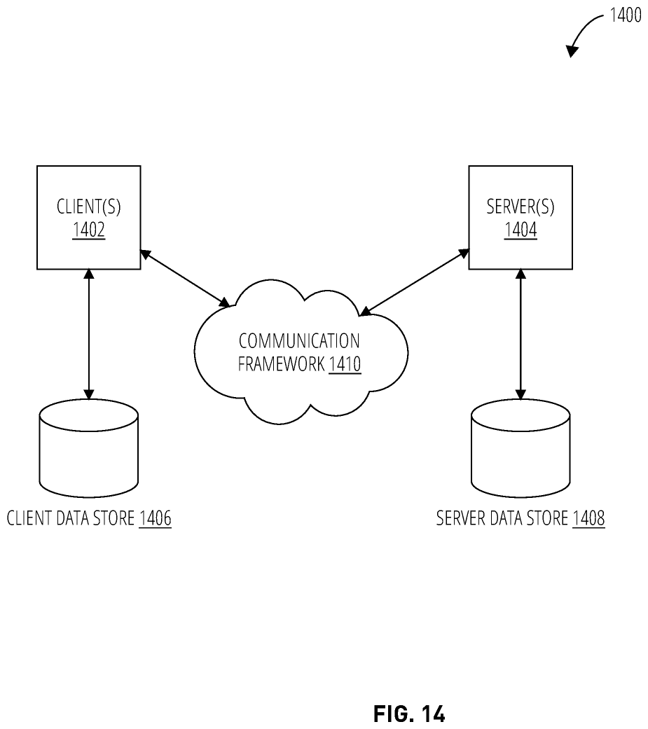

FIG. 14 is a block diagram depicting an exemplary communications architecture 1400 suitable for implementing various embodiments as previously described. The communications architecture 1400 includes various common communications elements, such as a transmitter, receiver, transceiver, radio, network interface, baseband processor, antenna, amplifiers, filters, power supplies, and so forth. The embodiments, however, are not limited to implementation by the communications architecture 1400, which may be consistent with systems discussed herein.

As shown in FIG. 14, the communications architecture 1400 includes one or more client(s) 1402 and server(s) 1404. The server(s) 1404 may implement one or more devices. The client(s) 1402 and the server(s) 1404 are operatively connected to one or more respective client data store 1406 and server data store 1408 that can be employed to store information local to the respective client(s) 1402 and server(s) 1404, such as cookies and/or associated contextual information.

The client(s) 1402 and the server(s) 1404 may communicate information between each other using a communication framework 1410. The communication framework 1410 may implement any well-known communications techniques and protocols. The communication framework 1410 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1410 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by client(s) 1402 and the server(s) 1404. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

1. A mobile device configured to automatically populate fields of webpages with new or updated information, comprising:
processing circuitry; and
a memory coupled with the processing circuitry, the memory to store an application including instructions that when executed by the processing circuitry, cause the processing circuitry to:
detect an initiation of a communication with a contactless card;
perform, via a wireless interface, the communication with the contactless card, the communication comprising receiving card authentication information from the contactless card;
detect one or more fields of a webpage of an online system, the one or more fields configured to receive data;
determine information to identify the online system;
communicate the card authentication information, and the information to identify the online system to a server, the server to obtain the data based on the card authentication information and the information to identify the online system;
receive the data from the server; and
automatically populate the one or more fields of the webpage with the data.

2. The mobile device of claim 1, the processing circuitry to display a prompt in a graphical user interface of a display, the prompt to indicate a user to bring the contactless card within an operating range of the wireless interface to initiate the communication with the contactless card.

3. The mobile device of claim 1, the instructions to cause the processing circuitry to detect the one or more fields based on labels for each of the one or more fields.

4. The mobile device of claim 1, wherein the wireless interface comprises a near-field communication (NFC) interface, and the communication is accordance with an NFC protocol.

5. The mobile device of claim 1, wherein the card authentication information is received encrypted with a diversified key based on a counter value stored on the contactless card and a master key.

6. The mobile device of claim 1, the processing circuitry to receive, from the server, a suggestion of data options to populate at least one of the one or more fields.

7. The mobile device of claim 6, comprising a display device, and the processing circuitry to:
present, on the display device, the suggestion of data options;
receive an input selection for at least one of the data options; and
populate at least one of the fields of the one or more fields with a selected data option.

8. The mobile device of claim 6, comprising a display device, and the processing circuitry to:
present, on the display device, the suggestion of data options;
receive an input selection for at least one of the data options; and
send the input selection for at least one of the data options to the server; and
receive the data based on the input selection to populate at least one of the fields of the one or more fields.

9. A system, comprising:
one or more processors;
memory coupled with the one or more processors, the memory to store instructions that when executed by the one or more processors, cause the one or more processors to:
receive, from a mobile device, card authentication information associated with a contactless card, and identity information to identify an online system;
perform an authentication operation associated with the contactless card based on the card authentication information;
determine whether the authentication operation is successful or unsuccessful;
in response to the authentication operation being successful, determine data capable to populate one or more fields of a webpage associated with the online system and send the data to the mobile device;
in response to the authentication operation being unsuccessful, send an indication to the mobile device to indicate an unsuccessful authentication of the card authentication information.

10. The system of claim 9, the one or more processors to:
determine the data exists for the online system and the contactless card stored in the memory; and
obtain the data from the memory to send to the mobile device.

11. The system of claim 9, the one or more processors to:
determine that data does not exist for the online system and the contactless card;
generate the data for the online system to send to the mobile device.

12. The system of claim 9, the one or more processors, to perform the authentication operation, to:
increment a counter value associated with the contactless card;
generate a diversified key based on the counter value and a master key associated with an account associated with the contactless card;
decrypt the card authentication information using the diversified key.

13. The system of claim 9, the one or more processors to:
determine optional data for the one or more fields of the webpage, the optional data comprising one or more options to populate at least one of the one or more fields of the webpage; and
send the optional data to the mobile device.

14. The system of claim 13, the one or more processors to:
process a response communication to the optional data, the response communication comprising a selection indication of the optional data;
determine the data associated with the selection indication; and
send the data associated with the selection indication to the mobile device.

15. A computing device, comprising:
processing circuitry; and
memory coupled with the processing circuitry, the memory to store instructions that when executed by the processing circuitry, cause the processing circuitry to:
detect one or more fields of a webpage to populate with data;
perform an authentication operation with card authentication information from a contactless card to authenticate a user;
determine the data to populate the one or more fields based on the webpage and a successful result of the authentication operation; and
populate the one or more fields of the webpage with the data.

16. The computing device of claim 15, the instructions to cause the processing circuitry to receive and process card authentication information from the contactless card in a near-field communication to perform the authentication operation.

17. The computing device of claim 15, the instructions to cause the processing circuitry to:
determine information to identify the webpage; and
determine the data based on the information to identify the webpage.

18. The computing device of claim 17, the instructions to cause the processing circuitry to:
send the information to identify the webpage and the card authentication information to a server associated with a banking system; and
receive the data from the server.

19. The computing device of claim 17, wherein the memory comprises at least a portion of the data, and the instructions to cause the processing circuitry to determine the at least the portion of the data to populate at least one of the one or more fields.

20. The computing device of claim 19, wherein the portion of the data is stored in the memory associated with the information to identify the webpage.
